(19) United States
(12) Patent Application Publication
(10) Pub. No.: US 2002/0190588 A1
(43) Pub. Date: Dec. 19, 2002

(54) Electric motor grounding with plastic end bells

(76) Inventors: Dale Koenigs, St. Cloud, WI (US); Thomas Linder, Grafton, WI (US); Richard Wieck, Grafton, WI (US); Arcady Royzen, Brown Deer, WI (US)

Correspondence Address: BAKER & DANIELS, 111 E. WAYNE STREET, SUITE 800, FORT WAYNE, IN, 46802

(21) Appl. No.: 09/884,704

(22) Filed: Jun. 19, 2001

(51) Int. Cl. H02K 11/00

(52) U.S. Cl. 310/71

(57) ABSTRACT

An electric engine starter motor having a rotor, stator, and a housing for the electric motor. A plastic end bell is mounted on an end of the housing and comprises a plastic rectangular body having a metallic strip embedded therein, a bushing mounted on the plastic rectangular body, and a ground terminal in electrical communication with both the metallic strip and the bushing. A grounding circuit is created through the metallic strip, the bushing, and the ground terminal to ground the electric motor.

### BACKGROUND OF THE INVENTION

1. Field of Invention

The present invention relates to electric motors, specifically the grounding of small universal electric motors used in starters for engines.

2. Description of the Related Art

Prior approaches to grounding of motors have included using metallic motor housings having metallic end bells with apertures therein to provide access to motor and ground terminals and to provide an electrical connection for grounding, typically externally on the housing or end bells. Two problems with metal housings have been the metal housings and metal end bells may deteriorate due to exposure to the elements and the dies for making such housings and end bells wear rapidly. Additionally, the usage of metal for the housings and end bells proves to be expensive, although grounding the motor is relatively easy to do. When using a metal housing and a metal end bell, a screw could be used to connect the ground lead of the power supply and starter switch to the metal end cap to the motor.

Another approach has been to use plastic to form end bells for electric motors, while maintaining usage of metals for the motor housings. Again, the end bell includes apertures, which are used for connection to the motor terminals. However, such end bells have a problem of providing good electrical connections for grounding purposes. In grounding electric motors, an electrical connection must be made from the motor to a ground. Usage of metal for housing and the end bells allowed the connection between the motor and a ground to be made relatively easily; however, plastic does not allow that same ease of grounding because it is non-conductive.

What is needed is an end bell for an electric motor which does not deteriorate in the elements, but which still provides a good electrical connection between the motor and a ground lead for grounding purposes.

### SUMMARY OF THE INVENTION

A plastic end bell is provided which is to be used with a small electric motor having a rotor, stator, and a housing for the electric motor. The end bell generally includes a plastic body matching to the motor housing shape having a metallic strip preferably embedded therein, a bushing mounted on the plastic body, and a ground terminal in electrical communication with both the metallic strip and the bushing. A grounding circuit is created through the metallic strip, the bushing, and the ground terminal to ground the electric motor.

The plastic end bell is advantageous since such an end bell does not corrode when exposed to the elements. Additionally, the plastic end bell is less expensive than its metallic counterpart. The plastic end bell also provides a good electrical connection between the electric motor and the ground for grounding purposes through the metallic strip linking the bushing, which supports the rotor, to the ground terminal.

### BRIEF DESCRIPTION OF THE DRAWINGS

The above-mentioned and other features and advantages of this invention, and the manner of attaining them, will become more apparent and the invention itself will be better understood by reference to the following description of an embodiment of the invention taken in conjunction with the accompanying drawings, wherein:

FIG. 1A is a sectional view of an electric motor having a plastic end bell in accordance with the present invention;

FIG. 1B a view of a completely assembled end bell connected to an electric power supply;

FIG. 2 is a sectional view of the end bell of FIG. 1, taken along line 2-2 of FIG. 1;

FIG. 3 is an interior view of a disassembled end bell;

FIG. 4 is a sectional view of the end bell of FIG. 3, taken along line 4-4 of FIG. 3;

FIG. 5 is an exterior view of the end bell of FIG. 1B; and

FIG. 6 is a sectional view taken along line 6-6 of FIG. 5.

Corresponding reference characters indicate corresponding parts throughout the several views. The exemplification set out herein illustrates an embodiment of the invention and such exemplification is not to be construed as limiting the scope of the invention in any manner.

### DETAILED DESCRIPTION

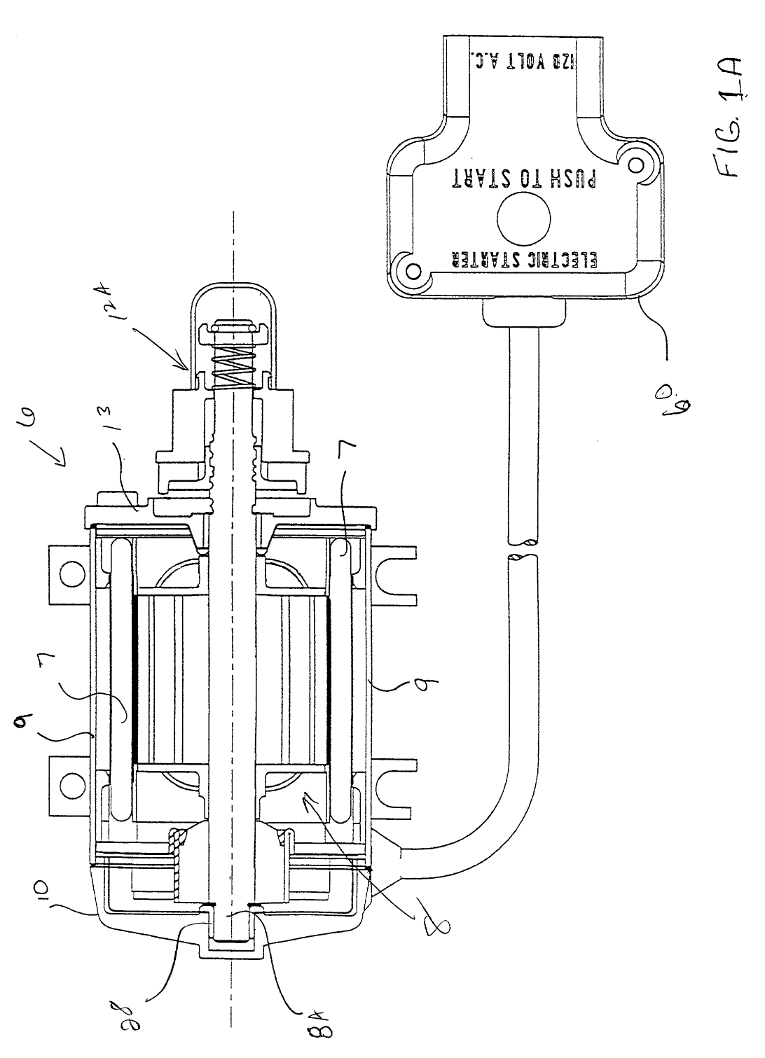

Referring first to FIG. 1A, electric motor 6 is shown connected to a conventional Bendix-type drive mechanism 12. Electric motor 6 may be any known AC or DC motor that is used in small engine applications. Electric motor 6 includes stator 7 and rotor 8 having driveshaft 8A, as in known in the art, and is housed within motor housing 9, which is connected to plastic end bells 10 and 13, described hereinbelow. Motor housing 9 may consist of any suitable material for a motor housing, such as steel, as is used in this embodiment, or other suitable metals, and in electrical contact with the stator lamination stack.

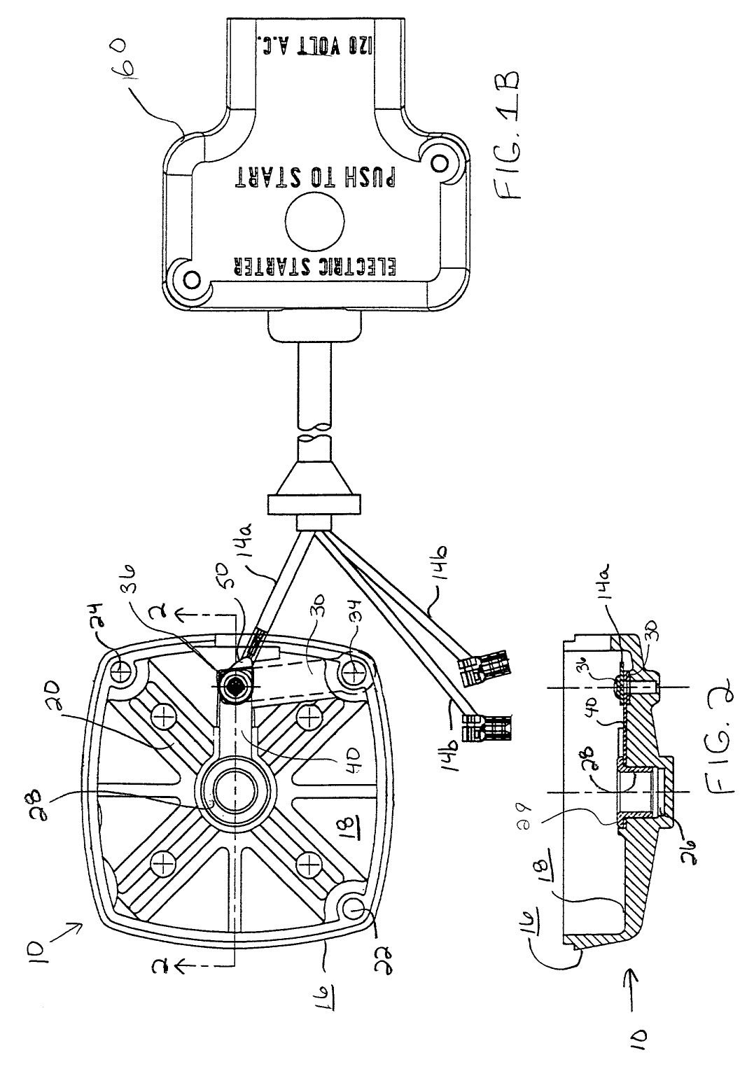

A completely assembled plastic end bell 10 is shown connected to electric power cord 14 with a switch module 60 containing ground wire 14a and motor wire 14b, End bell 10, molded of a non-conductive plastic material such as QUESTRA® (QUESTRA® is a registered trademark of The Dow Chemical Company of Midland, Mich.), ZYTEL®, or RYNITE® (ZYTEL® and RYNITE® are both registered trademarks of E. I. DuPont de Nemours and Company of Wilmington, Del.), includes exterior surface 16 and interior surface 18 having plastic ribs 20 molded thereon. Also molded in plastic end bell 10 are screw holes 22 and 34 that receive metal screws 24 for assembly of end bells 10 and 13 with motor housing 9 (FIG. 1A). In the center of plastic end bell 10 is bore 26, better shown in FIG. 2, for receipt of bushing 28 which is used to support one end of rotor shaft 8A of electric motor 6 (FIG. 1A). Bushing 28 may consist of any suitable metal for motor applications or may be substituted by a ball or roller bearing, but in this particular embodiment, bushing 28 is bronze. Embedded within end bell 10 is grounding strip 30 extending from ground screw hole 32, which receives removable grounding element, or ground screw, 34, to ground terminal 36, which receives ground lead 14a from switch module 60. Grounding strip 30 consists of a metallic material such as copper, tin, or brass and is embedded within plastic end bell 10 during molding of end bell 10. Self-threading ground screw 34 is in electrical communication with the field core (lamination stack) of electric motor 6. During final assembly of electric motor 6, additional strip 40, extending from bushing 28 to ground terminal 36, is added to the interior surface 18 of end bell 10 to complete the grounding circuit, thereby grounding rotor 8. Strip 40 is captured beneath the flange 29 of bushing 28.

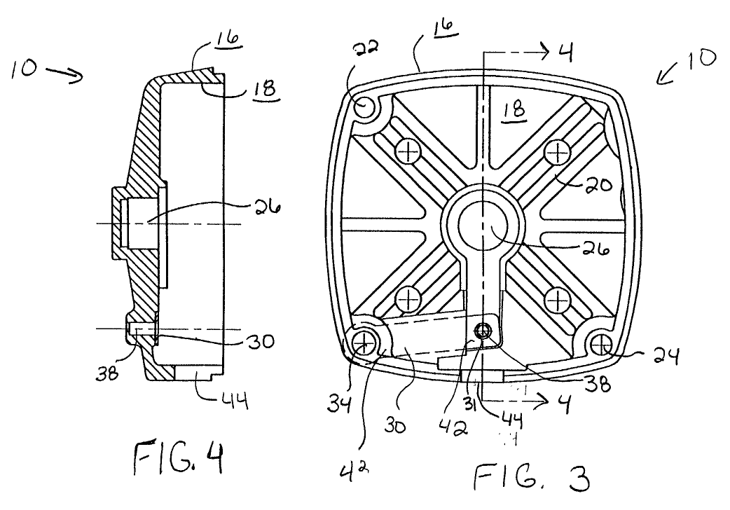

With reference to FIG. 2, a cross-section of completely assembled end bell 10 of FIG. 1B is shown. As shown, ground terminal 36 is a screw, although ground terminal 36 may be any suitable connection device. Ground terminal 36 is received in terminal bore 38 (FIGS. 3 and 4) after strip 40 is placed on interior surface 18 of end bell 10. This enables ground terminal 36 to be inserted through hole 31 in grounding strip 30 and a hole (not shown) in strip 40, then into bore 38. Ground box 14a may be connected to ground terminal 36 through any known means, such as U-clip 50. Through these connections, a grounding circuit is created through rotor 8, bushing 26, ground terminal 36, and ground lead 14a.

Referring to FIG. 3, disassembled plastic end bell 10 is shown without ground terminal 36 and without strip 40 on interior surface 18. Additionally, end bell 10 is shown with bushing 28 removed, thereby revealing empty bore 26. Grounding strip 30 is completely embedded within plastic end bell 10 during molding thereof except for exposed ends 41 and 42. Aperture 44, located in a side of end bell 10, allows lead 14a and 14b to enter end bell 10 for connection to ground terminal 36 and electric motor 6 respectively.

As shown in FIG. 4, end bell 10 is a rectangular body having a cup-shape, however, end bell 10 may be provided in any other shape depending on the motor and size, thereby being able to fit around stator 7 of electric motor 6 and to be properly seated on motor housing 9.

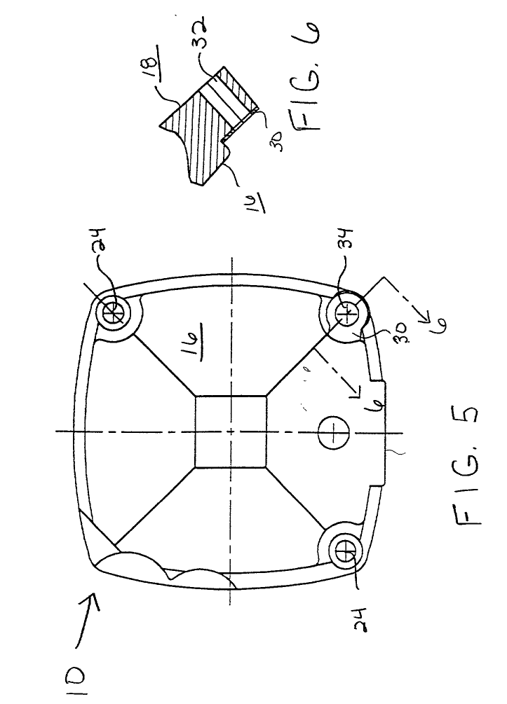

FIG. 5 shows the exterior of plastic end bell 10, including screws 24 that fasten end bell 10 to housing 9 and ground screw 34. Aperture 44 is located proximate ground terminal 36 to facilitate the entry of leads 14a and 14b. With reference to FIG. 6, ground screw hole 32 is formed in plastic end bell 10 to meet grounding strip 30, a portion of which is visible from the exterior of end bell 10 so that screw 34 (FIG. 1B) can make contact therewith.

While this invention has been described as having an exemplary structure, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An electric motor comprising:
a stator;
a rotor within said stator, said rotor including an output drive element;
a housing partially enclosing said stator and rotor;
a plastic end bell disposed over an end of said housing to enclose said stator and rotor, said end bell having a metallic bearing carried thereby, said bearing rotatably supporting an end of said drive element;
a ground terminal connected to said end bell, said terminal adapted for connection to an external ground lead; and
an internal grounding conductor in said end bell and being in electrical connection with said bearing, said stator and said ground terminal.

2. The electric motor of claim 1, wherein said end bell further includes at least one aperture therein, said aperture receiving a plurality of external electrical leads, one of said plurality of external electrical leads being a ground lead connected to said ground terminal.

3. The electric motor of claim 2, wherein said ground terminal extends above an interior surface of said end bell.

4. The motor of claim 1 wherein said bearing is a bushing and said rotor drive element is a shaft, one end of said shaft being received in said bushing.

5. The motor of claim 1 wherein said internal grounding conductor is a metal grounding strip at least partially embedded in said end bell.

6. The motor of claim 1 wherein said grounding conductor comprises a first grounding strip extending from said bearing to said ground terminal and a second grounding strip extending from said ground terminal and being electrically connected to said stator.

7. The motor of claim 6 wherein said motor housing is metallic and is in electrical contact with said stator, and including a plurality of metal screws connecting said end bell to said motor housing, and wherein said second grounding strip is in electrical connection with one of said metal screws.

8. The motor of claim 1 wherein said motor housing is metallic and is in electrical contact with the said stator, and including a plurality of metal screws connecting said end bell to said motor housing, wherein said internal grounding conductor electrically connects said ground terminal to at least one of said metal screws to thereby ground said stator.

9. The motor of claim 8 wherein said grounding conductor is a metallic grounding strip at least partially embedded in said end bell.

10. The motor of claim 9 wherein said grounding strip comprises a first grounding strip extending from said bearing to said ground terminal and a second grounding strip extending from said ground terminal to said at least one metal screw.

11. The motor of claim 1 wherein said motor is a starter motor for an engine and said starter motor includes a starter drive mechanism on an opposite end of said drive element from said end supported in said bearing.

12. The motor of claim 1 and including a second plastic end bell disposed on an opposite end of said motor housing.
